(19) United States
(12) Patent Application Publication
(10) Pub. No.: US 2024/0392685 A1
(43) Pub. Date: Nov. 28, 2024

(54) BOWED-ROTOR-RESISTANT LOW SHAFT

(71) Applicant: RAYTHEON TECHNOLOGIES CORPORATION, Farmington, CT (US)

(72) Inventor: WILLIAM K. ACKERMANN, East Hartford, CT (US)

(73) Assignee: RAYTHEON TECHNOLOGIES CORPORATION, Farmington, CT (US)

(21) Appl. No.: 18/324,697

(22) Filed: May 26, 2023

(51) Int. Cl. F01D 5/08

(52) U.S. Cl. CPC F01D 5/08; F05D 2220/321; F05D 2230/90; F05D 2240/61; F05D 2260/231

(57) ABSTRACT

A bowed-rotor-resistant low shaft of a gas turbine engine is provided. The bowed-rotor-resistant low shaft includes a low shaft and a thermal barrier coating applied to at least a lengthwise portion of an outside diameter of the low shaft, wherein the thermal barrier coating reduces bowing of the low shaft due to latent heating effects from the gas turbine engine.

### FIELD

The present disclosure relates generally to gas turbine engines and, more particularly, to a bowed-rotor-resistant low shaft of the gas turbine engine.

### BACKGROUND

Gas turbine engines, such as those that power modern commercial aircraft, include a fan section to propel the aircraft, a compressor section to pressurize a supply of air from the fan section, a combustor section to burn a hydrocarbon fuel in the presence of the pressurized air, and a turbine section to extract energy from the resultant combustion gases to power the compressor and fan sections.

### SUMMARY

A bowed-rotor-resistant low shaft of a gas turbine engine is disclosed herein. The bowed-rotor-resistant low shaft includes a low shaft and a thermal barrier coating applied to at least a lengthwise portion of an outside diameter of the low shaft, wherein the thermal barrier coating reduces bowing of the low shaft due to latent heating effects from the gas turbine engine.

In various embodiments, the bowed-rotor-resistant low shaft further includes a bond coat applied to the low shaft between the thermal barrier coating and the low shaft. In various embodiments, the bond coat is a ductile bond coat. In various embodiments, the bond coat is between 2 mils and 10 mils in thickness. In various embodiments, the bowed-rotor-resistant low shaft further includes an intermediate coat applied to the bond coat between the thermal barrier coating and the bond coat. In various embodiments, the intermediate coat is an intermediate graded coating.

In various embodiments, the thermal barrier coating is a high-porosity thermal barrier coating. In various embodiments, the thermal barrier coating is a pre-cracked columnar thermal barrier coating. In various embodiments, the thermal barrier coating is between 5 mils and 50 mils in thickness.

In various embodiments, the lengthwise portion of the low shaft is a length of the low shaft associated with at least one of an area associated with a location of at least one of a high-pressure compressor, a combustor, a high-pressure turbine, a mid-turbine frame, or a low-pressure turbine. In various embodiments, the lengthwise portion of the low shaft is a full length of the low shaft.

Also disclosed herein is a gas turbine engine. The gas turbine engine includes at least one of at least one of a high-pressure compressor, a combustor, a high-pressure turbine, a mid-turbine frame, or a low-pressure turbine; a low shaft; and a thermal barrier coating applied to at least a lengthwise portion of an outside diameter of the low shaft, wherein the thermal barrier coating reduces bowing of the low shaft due to latent heating effects from the at least one of the high-pressure compressor, the combustor, the high-pressure turbine, the mid-turbine frame, or the low-pressure turbine.

In various embodiments, the gas turbine engine further includes a bond coat applied to the low shaft between the thermal barrier coating and the low shaft. In various embodiments, the bond coat is a ductile bond coat. In various embodiments, the bond coat is between 2 mils and 10 mils in thickness. In various embodiments, the bowed-rotor-resistant low shaft further includes an intermediate coat applied to the bond coat between the thermal barrier coating and the bond coat. In various embodiments, the intermediate coat is an intermediate graded coating.

In various embodiments, the thermal barrier coating is a high-porosity thermal barrier coating. In various embodiments, the thermal barrier coating is a pre-cracked columnar thermal barrier coating. In various embodiments, the thermal barrier coating is between 5 mils and 50 mils in thickness.

In various embodiments, the lengthwise portion of the low shaft is a length of the low shaft associated with at least one of an area associated with a location of at least one of the high-pressure compressor, the combustor, the high-pressure turbine, the mid-turbine frame, or the low-pressure turbine. In various embodiments, the lengthwise portion of the low shaft is a full length of the low shaft.

Also disclosed herein is an aircraft. The aircraft includes a gas turbine engine. The gas turbine engine includes at least one of at least one of a high-pressure compressor, a combustor, a high-pressure turbine, a mid-turbine frame, or a low-pressure turbine; a low shaft; and a thermal barrier coating applied to at least a lengthwise portion of an outside diameter of the low shaft, wherein the thermal barrier coating reduces bowing of the low shaft due to latent heating effects from the at least one of the high-pressure compressor, the combustor, the high-pressure turbine, the mid-turbine frame, or the low-pressure turbine.

In various embodiments, the aircraft further includes a bond coat applied to the low shaft between the thermal barrier coating and the low shaft.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 schematically illustrates a gas turbine engine, in accordance with various embodiments.

FIG. 2 illustrates various components associated with a low shaft of a gas turbine engine, in accordance with various embodiments.

FIG. 3 illustrates hot-section latent engine heat from the gas turbine engine entering a low shaft post shutdown, in accordance with various embodiments.

FIG. 4 illustrates hot-section latent engine heat from the gas turbine engine entering a top-side of the low shaft post shutdown, in accordance with various embodiments.

FIG. 5 illustrates a visible physical bow due to non-uniform temperatures being generated in a low shaft, in accordance with various embodiments.

FIG. 6 illustrates a bowed-rotor-resistant low shaft of a gas turbine engine, in accordance with various embodiments.

### DETAILED DESCRIPTION

The detailed description of embodiments herein makes reference to the accompanying drawings, which show embodiments by way of illustration. While these embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not for limitation. For example, any reference to singular includes plural embodiments, and any reference to more than one component or step may include a singular embodiment or step. Also, any reference to attached, fixed, connected or the like may include permanent, removable, temporary, partial, full and/or any other possible attachment option. Further, any steps in a method discussed herein may be performed in any suitable order or combination.

Modern gas turbine engines operate extremely hot flow path temperatures in order to achieve high cycle efficiencies. Because of this, responsive to a gas turbine engine being shut down, there may still be a large amount of latent heat stored in the components of the gas turbine engine. As a result, it may take many hours for a typical gas turbine engine to cool down to an ambient temperature after operation. Furthermore, before cooling down to the ambient temperature, the latent heat stored in the components of the gas turbine engine, such as a combustor or a turbine, among others, radiate heat away from themselves to the other parts of the engine before the heat is ultimately radiated to the surrounding natural environment. So while the combustor and the turbine cool off post shutdown, other nearby components of the gas turbine engine may actually increase in temperature.

In typical gas turbine engines, the low shaft, which may also be referred to as a low-speed spool, is one of the components of the gas turbine engine that increases in temperature responsive to the combustor and turbine cooling down post shutdown. Since, the low shaft typically operates much cooler than the flow path because the low shaft is typically surrounded by cooled air and may also be effectively shielded from the primary flow path by other components of the gas turbine engine, the low shaft may be one of the components that attracts heat responsive to the combustor and turbine cooling down post shutdown. Unfortunately, since the gas turbine engine is shut down, the low shaft is no longer rotating and, since the low shaft is no longer rotating, one or more portions of the low shaft, e.g. a top-side of the low shaft or a back end of the low shaft, may heat up more than the other portions of the low shaft thereby creating what is commonly referred to as a “bowed-rotor” condition.

Responsive to a “bowed-rotor” condition, the low shaft takes on a visible physical bow, forming an arc like shape and attempts to start the gas turbine engine before the gas turbine engine has cooled down to the ambient temperature may generate violent engine vibrations due to an imbalance caused by the bow. This, in turn, may cause severe compressor and/or turbine blade-tip rubs that may significantly impact performance and/or operability levels.

Disclosed herein is method and system to generate a bowed-rotor-resistant low shaft of a gas turbine engine. In various embodiments, a thermal barrier coating (TBC) is applied to on outside diameter of the low shaft. In various embodiments, the thermal barrier coating may be a high-porosity thermal barrier coating. In various embodiments, a bond coat may be applied to the outside diameter of the low shaft prior to applying the high-porosity TBC to ensure adherence of the high-porosity TBC to the low shaft. Because the thermal conductivity of the metallic low shaft may be greater than a natural-convection/buoyancy average external heat transfer coefficient responsive to the engine being turned off (BIOT<<1), although heat may still be transferred, in various embodiments, by adding the high-porosity TBC, a rate of heat transfer may be sufficiently slowed so as to force the low shaft to heat up much more uniformly and without the top-side/bottom-side gradients that cause bowed-rotor events to occur. In various embodiments, the high-porosity TBC may benefit from being of a pre-cracked columnar high-porosity TBC, while the bond coat may benefit from being of a more ductile variety to arrest internal TBC cracks from entering a substrate of the low shaft. In various embodiments, pre-cracked columnar is identified as providing stress relieving cracks throughout the high-porosity TBC from an inside surface to an outside surface to relieve stress as opposed to larger stressed surface that may eventually sustain a larger crack.

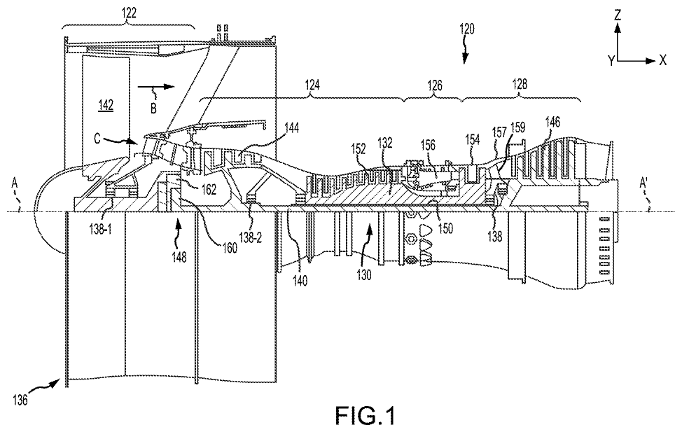

Referring now to the drawings, FIG. 1 schematically illustrates a gas turbine engine, in accordance with various embodiments. Gas turbine engine 120 may comprise a two-spool turbofan that generally incorporates a fan section 122, a compressor section 124, a combustor section 126, and a turbine section 128. In operation, fan section 122 may drive air along a bypass flow-path B, while compressor section 124 may further drive air along a core flow-path C for compression and communication into combustor section 126, before expansion through turbine section 128. FIG. 1 provides a general understanding of the sections in a gas turbine engine, and is not intended to limit the disclosure. The present disclosure may extend to all types of applications and to all types of turbine engines, including, for example, such as single spool engines, turbojets, turboshafts, and three spool (plus fan) turbofans wherein an intermediate spool includes an intermediate pressure compressor (“IPC”) between a Low-Pressure Compressor (“LPC”) and a High-Pressure Compressor (“HPC”), and an Intermediate-Pressure Turbine (“IPT”) between the High-Pressure Turbine (“HPT”) and the Low-Pressure Turbine (“LPT”).

In various embodiments, gas turbine engine 120 may comprise a low-speed spool 130, hereinafter referred to as low shaft 130, and a high-speed spool 132 mounted for rotation about an engine central longitudinal axis A-A′ relative to an engine static structure 136 via one or more bearing systems 138 (shown as, for example, bearing system 138-1 and bearing system 138-2 in FIG. 1). It should be understood that various bearing systems 138 at various locations may alternatively or additionally be provided, including, for example, bearing systems 138, bearing system 138-1, and/or bearing system 138-2. In various embodiments, the low shaft 130 and the high-speed spool 132 may be co-rotating, i.e. rotate in a same direction about engine central longitudinal axis A-A′. In various embodiments, the low shaft 130 and the high-speed spool 132 may be counter rotating, i.c. rotate in opposite directions about engine central longitudinal axis A-A′.

In various embodiments, low shaft 130 may comprise an inner shaft 140 that interconnects a fan 142, a low-pressure (or first) compressor section (“LPC”) 144, and a low-pressure (or first) turbine 146. Inner shaft 140 may be connected to fan 142 through a geared architecture 148 that can drive the fan 142 at a lower speed than low shaft 130. Geared architecture 148 may comprise a gear assembly 160 enclosed within a gear housing 162. Gear assembly 160 may couple the inner shaft 140 to a rotating fan structure. High-speed spool 132 may comprise an outer shaft 150 that interconnects a high-pressure compressor (“HPC”) 152 (e.g., a second compressor section) and high-pressure (or second) turbine section 154. A combustor 156 may be located between HPC 152 and high-pressure turbine 154. A mid-turbine frame 157 of engine static structure 136 may be located generally between high-pressure turbine 154 and low-pressure turbine 146. Mid-turbine frame 157 may support one or more bearing systems 138 in turbine section 128. Inner shaft 140 and outer shaft 150 may be concentric and may rotate via bearing systems 138 about engine central longitudinal axis A-A′. As used herein, a “high-pressure” compressor and/or turbine may experience a higher pressure than a corresponding “low-pressure” compressor and/or turbine.

In various embodiments, the air along core airflow C may be compressed by LPC 144 and HPC 152, mixed and burned with fuel in combustor 156, and expanded over high-pressure turbine 154 and low-pressure turbine 146. Mid-turbine frame 157 may comprise airfoils 159 located in core airflow path C. Low-pressure turbine 146 and high-pressure turbine 154 may rotationally drive the low shaft 130 and high-speed spool 132, respectively, in response to the expansion.

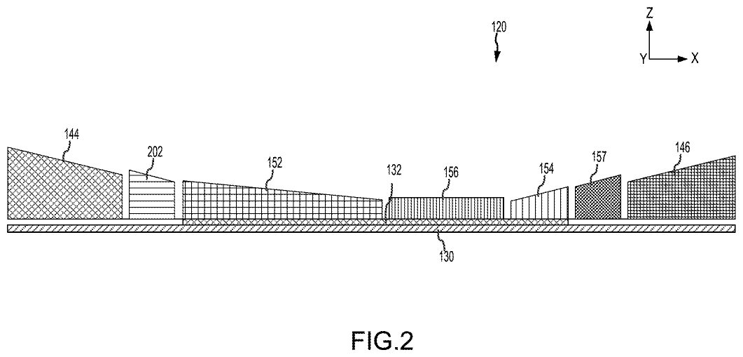

Referring now to FIG. 2, various components associated with a low shaft of a gas turbine engine are illustrated, in accordance with various embodiments. As discussed in FIG. 1, the gas turbine engine 120 illustrated in FIG. 2 may comprise a low shaft 130 and a high-speed spool 132 mounted for rotation about an engine central longitudinal axis, which is illustrated in FIG. 1, relative to an engine static structure. In various embodiments, the low shaft 130 may interconnect the LPC 144 and the low-pressure turbine 146. In various embodiments, the low shaft 130 may traverse the mid-turbine frame (“MTF”) 157 and an intermediate case (“IMC”) 202 and may be supported by bearings coupled to the MTF 157 and the IMC 202. In various embodiments, the high-speed spool 132 may interconnect the HPC 152 and the high-pressure turbine 154. In various embodiments, the high-speed spool 132 may traverse the combustor 156. In that regard, the low shaft 130 and the high-speed spool 132 may be concentric and may rotate about engine central longitudinal axis A-A′.

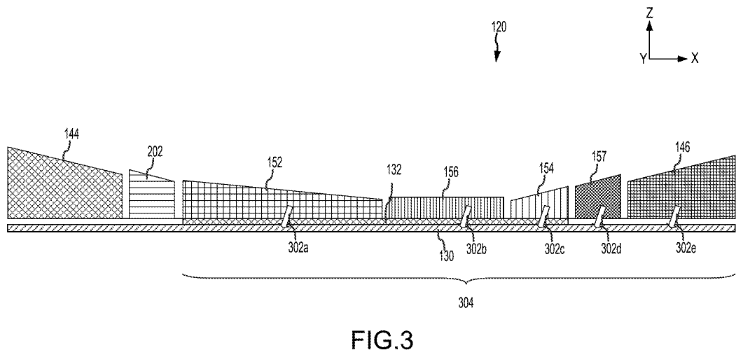

Referring now to FIG. 3, hot-section latent engine heat from the gas turbine engine entering a low shaft post shutdown is illustrated, in accordance with various embodiments. In various embodiments, responsive to the gas turbine engine 120 being shut down, there may still is a tremendous amount of latent heat stored in components of the gas turbine engine 120, such as in the HPC 152, the combustor 156, the high-pressure turbine 154, the mid-turbine frame 157, and the low-pressure turbine 146. In various embodiments, before the gas turbine engine 120 cools down to an ambient temperature, the latent heat stored in the HPC 152, the combustor 156, the high-pressure turbine 154, the mid-turbine frame 157, and the low-pressure turbine 146, radiate heat, illustrated by arrows 302a, 302b, 302c, 302d, and 302e, respectively, to at least the low shaft 130 before the heat is ultimately radiated to the surrounding natural environment. Since, the low shaft 130 typically operates much cooler than the flow path because the low shaft is typically surrounded by cooled air and may also be effectively shielded from the primary flow path by other components of the gas turbine engine 120, the low shaft 130 may attract heat 302a, 302b, 302c, 302d, and 302e responsive to the HPC 152, the combustor 156, the high-pressure turbine 154, the mid-turbine frame 157, and the low-pressure turbine 146 cooling down post shutdown. Unfortunately, since the gas turbine engine 120 is shut down, the low shaft 130 is no longer rotating and, since the low shaft is no longer rotating, one or more portions of the low shaft 130, e.g. a top-side of the low shaft 130, i.e. in the z-direction, or a portion 304 of the low shaft 130, i.c. in the x-direction, that may heat up more than the other portions of the low shaft 130 thereby creating a “bowed-rotor” condition.

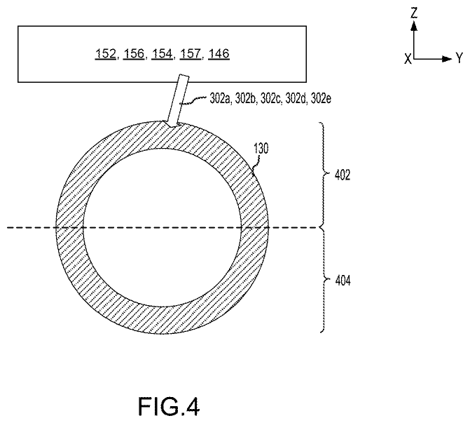

Referring now to FIG. 4, hot-section latent engine heat from the gas turbine engine entering a top-side of the low shaft post shutdown is illustrated, in accordance with various embodiments. A described previously, a tremendous amount of latent heat stored in components of the gas turbine engine 120, such as in the HPC 152, the combustor 156, the high-pressure turbine 154, the mid-turbine frame 157, and the low-pressure turbine 146 and, before the gas turbine engine 120 cools down to an ambient temperature, the latent heat stored in the HPC 152, the combustor 156, the high-pressure turbine 154, the mid-turbine frame 157, and the low-pressure turbine 146, radiate heat, illustrated by arrows 302a, 302b, 302c, 302d, and 302e, respectively. Due to the location of the HPC 152, the combustor 156, the high-pressure turbine 154, the mid-turbine frame 157, and the low-pressure turbine 146 in the gas turbine engine 120, the heat 302a, 302b, 302c, 302d, and 302e may generate non-uniform temperatures in the low shaft 130 such that an upper portion 402, i.e. in the z-direction, experiences a higher heat than a lower portion 404, i.e. in the z-direction, which may result in the low shaft 130 taking on a visible physical bow, much like a rainbow.

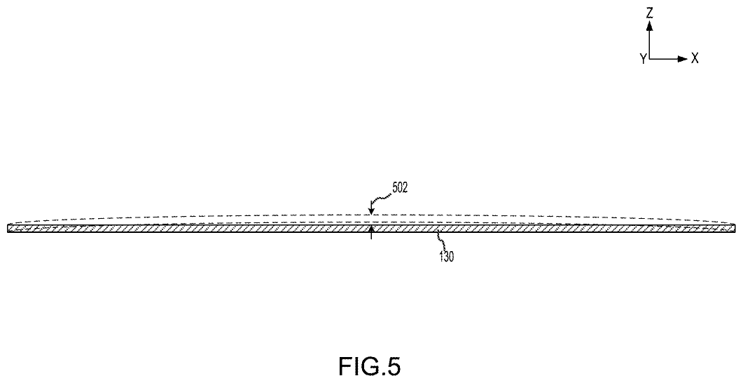

FIG. 5 illustrates a visible physical bow due to non-uniform temperatures being generated in a low shaft, in accordance with various embodiments. In various embodiments, the bow 505, which is in the z-direction, may be a 40-mil displacement from the top edge of the low shaft 130 in a non-bowed condition versus a top edge of the low shaft 130 in a bowed condition. In various embodiments, the bow 505, which is in the z-direction, may be a 30-mil displacement from the top edge of the low shaft 130 in a non-bowed condition versus a top edge of the low shaft 130 in a bowed condition. In various embodiments, the bow 505, which is in the z-direction, may be a 20-mil displacement from the top edge of the low shaft 130 in a non-bowed condition versus a top edge of the low shaft 130 in a bowed condition. In various embodiments, the bow 505, which is in the z-direction, may be a 5-mil displacement from the top edge of the low shaft 130 in a non-bowed condition versus a top edge of the low shaft 130 in a bowed condition. In that regard, the bow 505, which is in the z-direction, may be any displacement from the top edge of the low shaft 130 in a non-bowed condition versus a top edge of the low shaft 130 in a bowed condition that is dependent on engine size, flight mission segment, or shaft length, among others. Again, any attempt to start the gas turbine engine before the gas turbine engine has cooled down to the ambient temperature may generate violent engine vibrations due to an imbalance caused by the bow 502 in the low shaft 130. This, in turn, may cause severe compressor and/or turbine blade-tip rubs that may significantly impact performance and/or operability levels.

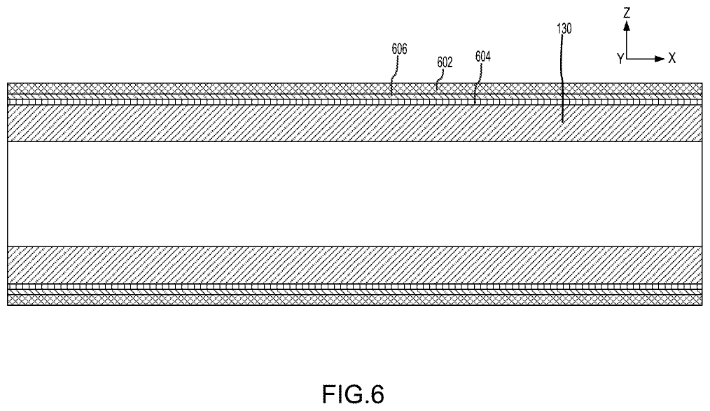

Referring now to FIG. 6, a bowed-rotor-resistant low shaft of a gas turbine engine is illustrated, in accordance with various embodiments. In various embodiments, in order to reduce or eliminate a “bowed-rotor” condition from occurring the low shaft 130, a thermal barrier coating (TBC) 602 is applied to on outside diameter of the low shaft 130. In various embodiments, the thermal barrier coating (TBC) 602 may be a high-porosity thermal barrier coating (TBC). In various embodiments, the high-porosity TBC 602 may include Zirconia, Alumina, or other yttria-stabilized material, among others. In that regard, in various embodiments, the high-porosity TBC 602 may be a high-porosity ceramic TBC. In various embodiments, porosity indicates a quality or degree of having minute spaces or holes through which liquid or air may pass or reside. In that regard, high porosity indicates a low thermal conductivity due to the presence of a high density of air pockets. In various embodiments, the high porosity TBC 602 may be applied by a high-temperature spray device. In various embodiments, the high-porosity TBC 602 may be applied to outside diameter along a full length, i.e. in the x direction, of the low shaft 130. In various embodiments, the high-porosity TBC 602 may be applied to outside diameter along a lengthwise portion, such as portion 304 of FIG. 3, of the low shaft 130 in an area associated with a location of the HPC 152, the combustor 156, the high-pressure turbine 154, the mid-turbine frame 157, and the low-pressure turbine 146 of FIG. 3. In various embodiments, the high-porosity TBC 602 may be between 5 mils (0.127 millimeters) and 50 mils (1.27 millimeters) in thickness. In various embodiments, the high-porosity TBC 602 may be between 7 mils (0.1778 millimeters) and 30mils (0.762 millimeters) in thickness. In various embodiments, the high-porosity TBC 602 may be between 10 mils (0.254 millimeters) and 20 mils (0.508 millimeters) in thickness. In various embodiments, a thickness of the high-porosity TBC 602 may be a function of specific engine boundary conditions, such as size of the bow to be eliminated which may be caused by the amount of heat that may be added to the low shaft 130 which is effected by engine size, flight mission segment, or shaft length, among others. In various embodiments, the high-porosity TBC 602 may be a pre-cracked columnar variety high-porosity TBC. In various embodiments, a durability of the high-porosity TBC 602 may be enhanced by selectively controlling a temperature of the low shaft 130 during application.

In various embodiments, a bond coat 604 may be applied to the outside diameter of the low shaft 130 prior to applying the high-porosity TBC 602 to ensure adherence of the high-porosity TBC 602 to the low shaft 130. In various embodiments, the bond coat 604 may be applied by a high-temperature spray device. In various embodiments, the bond coat 604 may include Nickel (Ni), Chromium (Cr), or metal alloys, among others. In various embodiments, the bond coat 604 may be between 2 mils (0.0508 millimeters) and 10 mils (0.254 millimeters) in thickness. In various embodiments, the bond coat 604 may be between 3 mils (0.0762 millimeters) and 7 mils (0.1778 millimeters) in thickness. In various embodiments, the bond coat 604 may be between 4 mils (0.1016 millimeters) and 6 mils (0.1524 millimeters) in thickness. In various embodiments, the bond coat 604 may be a ductile bond coat to arrest internal TBC cracks from entering a substrate of the low shaft 130. Because the thermal conductivity of a metal of the low shaft 130 may be greater than a natural-convection/buoyancy average external heat transfer coefficient responsive to the engine being turned off (BIOT<<1), although heat will still be transferred, in various embodiments, by adding the high-porosity TBC 602, a rate of heat transfer may be sufficiently slowed so as to force the low shaft 130 to heat up much more uniformly and without the top-side/bottom-side gradients that may cause a “bowed-rotor” condition to occur.

In various embodiments, one or more intermediate coats 606 may be applied to the bond coat 604 prior to applying the high-porosity TBC 602. In various embodiments, the one or more intermediate coats 606 may be applied by high-temperature spray device. In various embodiments, the one or more intermediate coats 606 may be a NiCoCrAlY alloy, including Nickel (Ni), Cobalt (Co), Chromium (Cr), Aluminum (Al) and Yttrium (Y). In various embodiments, the one or more intermediate coats 606 may be between 4 mils (0.1016 millimeters) and 20 mils (0.508 millimeters) in thickness. In various embodiments, the one or more intermediate coats 606 may be between 8 mils (0.2032 millimeters) and 16 mils (0.4064 millimeters) in thickness. In various embodiments, the one or more intermediate coats 606 may be between 10 mils (0.254 millimeters) and 14 mils (0.3556 millimeters) in thickness. In various embodiments, the one or more intermediate coats 606 may have properties between those of the bond coat 604 and the high-porosity TBC 602 that assists in transitions coating stresses. In that regard, in various embodiments, the one or more intermediate coats 606 may be of constant composition that is part metallic and part ceramic. In various embodiments, the one or more intermediate coats 606 may have non-constant material properties as a function of layer thickness, such that an innermost one of the one or more intermediate coats 606 is more metallic and an outermost one of the one or more intermediate coats 606 is more ceramic. In that regard, in various embodiments, the one or more intermediate coats 606 may be an intermediate graded coating that is continuously-graded providing a blended transition that further reduces internal coating stresses at material interfaces to help prevent spallation and/or delamination. In various embodiments, graded indicates variable material composition that yields variable material properties as a function of layer thickness.

Accordingly, extremely low thermal conductivity provided by the high-porosity TBC 602 significantly slows a rate of inbound heat transfer that high thermal conductivity of a metallic substrate of the low shaft 130 uniformly distributes post shutdown such that upper and lower sections of the low shaft 130 tend to approximately be at a same temperature as a function of time [BIOT Number<<1], thereby reducing or preventing bowing in the low shaft 130 and thus, reducing or avoiding associated startup and “gate-turn-around time” issues.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C. B and C, or A and B and C.

Systems, methods, and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A bowed-rotor-resistant shaft of a gas turbine engine, comprising:
a shaft;
a thermal barrier coating applied to at least a lengthwise portion of an outside diameter of the shaft, wherein the thermal barrier coating reduces bowing of the shaft due to latent heating effects from the gas turbine engine;
a bond coat applied to the shaft between the thermal barrier coating and the shaft, wherein the bond coat comprises at least one of Nickel (Ni) or Chromium (Cr); and
an intermediate coat applied to the bond coat between the thermal barrier coating and the bond coat, wherein the intermediate coat is graded coating and wherein the intermediate coat is a NiCoCrAlY alloy comprising Nickel (Ni), Cobalt (Co), Chromium (Cr), Aluminum (Al), and Yttrium (Y).

2. (canceled)

3. The bowed-rotor-resistant shaft of claim 1, wherein the bond coat is a ductile bond coat and wherein the bond coat is between 2 mils and 10 mils in thickness.

4-5. (canceled)

6. The bowed-rotor-resistant shaft of claim 1, wherein the thermal barrier coating is a pre-cracked columnar thermal barrier coating.

7. The bowed-rotor-resistant shaft of claim 1, wherein the thermal barrier coating is between 5 mils and 50 mils in thickness.

8. The bowed-rotor-resistant shaft of claim 1, wherein the lengthwise portion of the shaft is a length of the shaft associated with at least one of an area associated with a location of at least one of a high-pressure compressor, a combustor, a high-pressure turbine, a mid-turbine frame, or a low-pressure turbine.

9. The bowed-rotor-resistant shaft of claim 1, wherein the lengthwise portion of the shaft is a full length of the shaft.

10. A gas turbine engine, comprising:
at least one of at least one of a high-pressure compressor, a combustor, a high-pressure turbine, a mid-turbine frame, or a low-pressure turbine;
a shaft;
a thermal barrier coating applied to at least a lengthwise portion of an outside diameter of the shaft, wherein the thermal barrier coating reduces bowing of the shaft due to latent heating effects from the at least one of the high-pressure compressor, the combustor, the high-pressure turbine, the mid-turbine frame, or the low-pressure turbine;
a bond coat applied to the shaft between the thermal barrier coating and the shaft, wherein the bond coat comprises at least one of Nickel (Ni) or Chromium (Cr); and
an intermediate coat applied to the bond coat between the thermal barrier coating and the bond coat, wherein the intermediate coat is graded coating and wherein the intermediate coat is a NiCoCrAlY alloy comprising Nickel (Ni), Cobalt (Co), Chromium (Cr), Aluminum (Al), and Yttrium (Y).

11. (canceled)

12. The gas turbine engine of claim 10, wherein the bond coat is a ductile bond coat and wherein the bond coat is between 2 mils and 10 mils in thickness.

13-14. (canceled)

15. The gas turbine engine of claim 10, wherein the thermal barrier coating is a pre-cracked columnar thermal barrier coating.

16. The gas turbine engine of claim 10, wherein the thermal barrier coating is between 5 mils and 50 mils in thickness.

17. The gas turbine engine of claim 10, wherein the lengthwise portion of the shaft is a length of the shaft associated with at least one of an area associated with a location of at least one of the high-pressure compressor, the combustor, the high-pressure turbine, the mid-turbine frame, or the low-pressure turbine.

18. The gas turbine engine of claim 10, wherein the lengthwise portion of the shaft is a full length of the shaft.

19. An aircraft comprising:
a gas turbine engine, the gas turbine engine comprising:
at least one of at least one of a high-pressure compressor, a combustor, a high-pressure turbine, a mid-turbine frame, or a low-pressure turbine;
a shaft; and
a thermal barrier coating applied to at least a lengthwise portion of an outside diameter of the shaft, wherein the thermal barrier coating reduces bowing of the shaft due to latent heating effects from the at least one of the high-pressure compressor, the combustor, the high-pressure turbine, the mid-turbine frame, or the low-pressure turbine;
a bond coat applied to the shaft between the thermal barrier coating and the shaft, wherein the bond coat comprises at least one of Nickel (Ni) or Chromium (Cr); and
an intermediate coat applied to the bond coat between the thermal barrier coating and the bond coat, wherein the intermediate coat is graded coating and wherein the intermediate coat is a NiCoCrAlY alloy comprising Nickel (Ni), Cobalt (Co), Chromium (Cr), Aluminum (Al), and Yttrium (Y).

20. (canceled)
